(19) United States
(12) Patent Application Publication
(10) Pub. No.: US 2012/0197675 A1
(43) Pub. Date: Aug. 2, 2012

(54) AUTOMATED CONTROL PLAN

(75) Inventors: Willard H. Waldron, III, Charlotte, NC (US); Kerry Michelle Cantley, Fort Mill, SC (US); Colin W. Ledoux, Waxhaw, NC (US)

(73) Assignee: Bank of America Corporation, Charlotte, NC (US)

(21) Appl. No.: 13/016,590

(22) Filed: Jan. 28, 2011

(51) Int. Cl. G06Q 10/00

(52) U.S. Cl. 705/7.11

(57) ABSTRACT

Embodiments of the present invention provide apparatuses and methods for automatic control plan monitoring. Users can enter the steps of the business process that requires monitoring, the metrics that the user wants to track for a specific control plan, the control limits for the metrics, and/or the location where the metric data can be captured. Thereafter, an automated control plan captures the data and provides customized dashboards so that users can track the metrics associated with the control plan from the beginning of the process until the end, as well as make comparisons of the process over time. Furthermore, notification alerts can be set that alert the proper employees within the business when the control plan is outside of the control plan limits.

### FIELD

This invention relates generally to the field of process monitoring, and more particularly embodiments of the invention relate to apparatuses and methods for automatic control plan monitoring.

### BACKGROUND

Businesses are constantly trying to find ways to improve the quality, speed, cost, and risk associated with their goods and services (“products”). Some businesses have developed monitoring applications which track the processes related to the business's products in order to improve the quality, speed, cost and risks associated with the products. One issue with these monitoring systems is that they are only as good as the metrics that they monitor and measure. Therefore, it is of particular importance that the businesses develop detailed process maps, and identify the critical metrics and key performance indicators (“metrics”) that best define and control the process. Many frameworks have been developed and used over time to monitor processes and metrics, once such framework is the Six Sigma methodology.

Six sigma methodologies provide statistical analysis techniques for reducing process variation. Application of six sigma tools and methodology within a Define, Measure, Analyze, Improve, and Control (DMAIC) structure provides an approach for reducing process variation. Six sigma has been applied to manufacturing, design, management, and business processes, to name a few, in order to search for variations in the processes and to detect the cause of such variations. The general six sigma methodology can be used for evaluating a process, defining the important metrics in that process, measuring the metrics, analyzing the change in the metrics, improving the process, and controlling the process by measuring the metrics over time. However, it is still just a general framework that cannot be applied to all processes and must be expanded and added to in order to be applicable to specific processes.

After a six sigma process or related process improvement tool is utilized a control plan is formed in order to monitor the process. Control plans are a structured approach for monitoring processes by focusing the business on the metrics related to the characteristics of the processes that are important to the business. The control plans provide a reaction plan in case an out of control condition occurs within the process. They allow process owners and others within business to track critical metrics and key performance indicators to determine if the process is performing in the way in which it was designed and anticipated to perform.

A control plan is a living plan that should be updated and changed based on changes in the process or process characteristics, specifications, measurements, data sampling, control methods, and/or reaction plans. However, control plans can become static documents that are not properly used because of changes to the process owners, time constraints on employee time, continuous compliance such that the plan gets overlooked over time, etc. In some situations control plans are only revisited when a process strays outside of the control plan limits and management inquires as to why customers or the business's bottom line are being affected.

Therefore, specific methods and systems are needed to help make the control plan a relevant monitoring tool over time.

### BRIEF SUMMARY

Embodiments of the present invention address the above needs and/or achieve other advantages by providing apparatuses (e.g., a system, computer program product, and/or other device) and methods for automatic control plan monitoring. Users can enter the steps of the business process that requires monitoring, the metrics that the user wants to track for a specific control plan, the control limits for the metrics, and/or the location where the metric data can be captured. Thereafter, an automated control plan captures the data and provides customized dashboards so that users can track the metrics associated with the control plan from the beginning of the process until the end, as well as make comparisons of the process over time. Furthermore, notification alerts can be set that alert the proper employees within the business when the control plan is outside of the control plan limits.

Embodiments of the invention relate to systems, methods, and computer program products for receiving a metric for monitoring a process step within a business process; receiving a first control limit associated with the metric; generating a customized control plan based on the metric, the first control limit, and the process step, through the use of a processing device; receiving metric data for the process step; and generating a first notification alert when the metric data violates the first control limit.

In further accord with an embodiment of the invention, there are two or more metrics for monitoring two or more process steps for the business process.

In another embodiment of the invention, the invention further comprises displaying to a user the customized control plan in a customized control plan interface with a status indicator, wherein the status indicator illustrates if the metric violates the first control limit.

In yet another embodiment of the invention, the invention further comprises receiving a second control limit associated with the metric and generate a second notification alert when the metric data violates the second control limit, wherein the first notification alert is a first form of communication and the second notification alert is a second form of communication.

In still another embodiment of the invention, the invention further comprises receiving notification contact information of a second process owner automatically when a first process owner for the customized control plan is replaced by the second process owner, and update the customized control plan with the notification contract information of the second process owner.

In further accord with an embodiment of the invention, receiving the metric data for the process step comprises receiving the metric data for the process step from a business activity monitoring system that captures metric data from business systems.

In another embodiment of the invention, receiving the metric data for the process step comprises receiving the metric data for the process step from a business system that executes the process step.

In yet another embodiment of the invention, the invention further comprises generating a chart for the metric based on the metric data illustrating the metric data over time as the metric data relates to the first control limit.

The features, functions, and advantages that have been discussed may be achieved independently in various embodiments of the present invention or may be combined in yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides a high level process flow illustrating a customized control plan process, in accordance with an embodiment of the present invention;

FIG. 2 provides a control plan system environment, in accordance with an embodiment of the present invention;

FIG. 3 provides a process map illustrating a detailed customized control plan process, in accordance with one embodiment of the present invention;

FIG. 4 provides a control plan monitoring interface, in accordance with one embodiment of the present invention;

FIG. 5 provides a control chart volume interface, in accordance with one embodiment of the present invention; and

FIG. 6 provides a control chart defect interface, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Although some embodiments of the invention described herein are generally described as involving a “bank,” one of ordinary skill in the art will appreciate that other embodiments of the invention may involve other businesses or financial institutions that take the place of or work in conjunction with the bank to perform one or more of the processes or steps described herein as being performed by a bank. Still in other embodiments of the invention the bank or financial institution described herein may be replaced with other types of businesses that perform business activity monitoring and/or control plan monitoring.

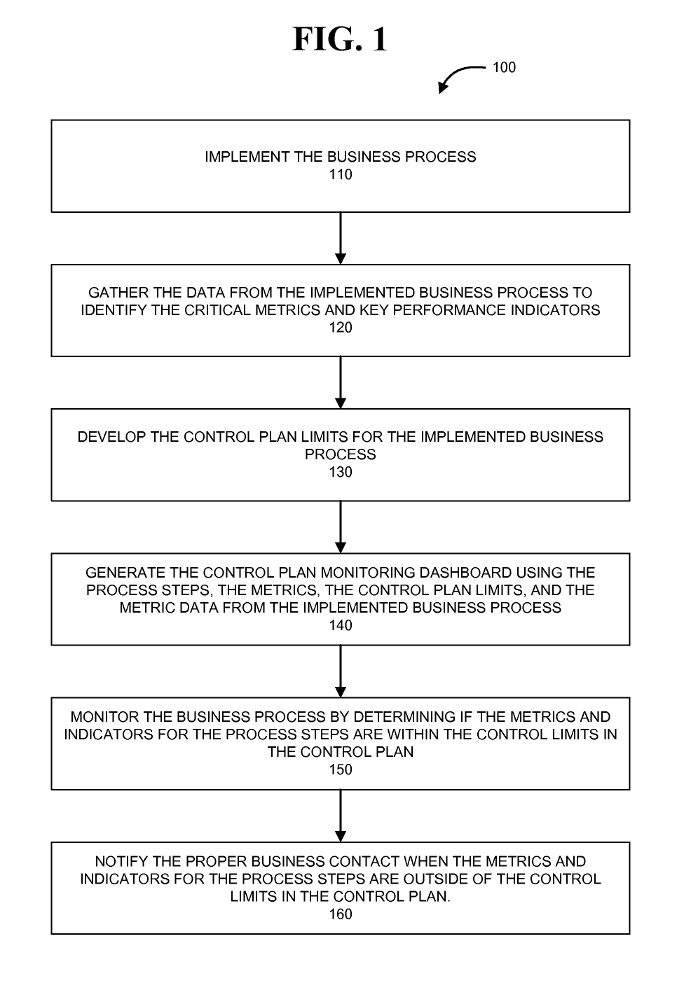

FIG. 1 illustrates a high level process flow for a customized control plan process. As illustrated in block 110 of FIG. 1, the business process or business process changes that resulted from a process improvement tool are implemented within the business. Thereafter, as illustrated by block 120, data is gathered from the business process in order to identify critical metrics and key performance indicators of the process. After the critical metrics and key performance indicators are identified, then as illustrated in block 130, the control plan limits for the process are determined and set within the control plan. As illustrated by block 140 in FIG. 1, the control plan monitoring interface, such as a dashboard, is automatically generated using the business process step to be monitored, the metrics identified, the control plan limits set by the user, and/or the location of the data captured from the implemented business process. Thereafter, as illustrated by block 150 in FIG. 1, the control plan is monitored automatically to determine if the business process is within the control limits. As illustrated by block 160, the process owner and/or other employees within the associated business lines for the process are notified when the critical metrics and key performance indicators are outside of the control plan limits.

Control plans are typically created as part of a project within a business. During the project a business process is created and the control plan outlines how that business process should be implemented, run, and/or monitored. Once the project team completes the project, they usually pass the responsibility of running and monitoring the business process to the respective line of business, and thereafter focus on other projects within the business. Therefore, control plans developed by the project team are not always kept up to date, followed, or used correctly when the line of business takes over after the initial project is completed.

Embodiments of this invention relate to systems and methods for setting up automated control plans requiring little or no human interaction to create them. In some embodiments, the control plan can be created without requiring additional data collection or consolidation by the business activity monitoring systems, which as explained in greater detail below, capture data from business processes within the business. The automated control plans provide sustainability, reduce the risk, and organize and unify business process data. The automated control plan provides sustainability by continuously monitoring the critical metrics and key performance indicators as opposed to monitoring the critical metrics and key performance indicator through a discontinuous user intensive process. The automated control plan reduces risk by providing consistent monitoring of an ongoing process automatically as opposed to manual investigation and notification of process steps, which may not identify when the process steps are outside to the of control plan limits before the business is negatively affected. The data is organized and unified to allow process owners to focus on other aspects of their jobs, such as improving services, as opposed to monitoring processes because the monitoring is performed automatically using notification alerts when the process is out of control or trending toward becoming out of control. Embodiments of the invention shift the focus of control plans from reactive monitoring after the process is out of control to preventative monitoring after trending illustrates that the process might become out of control.

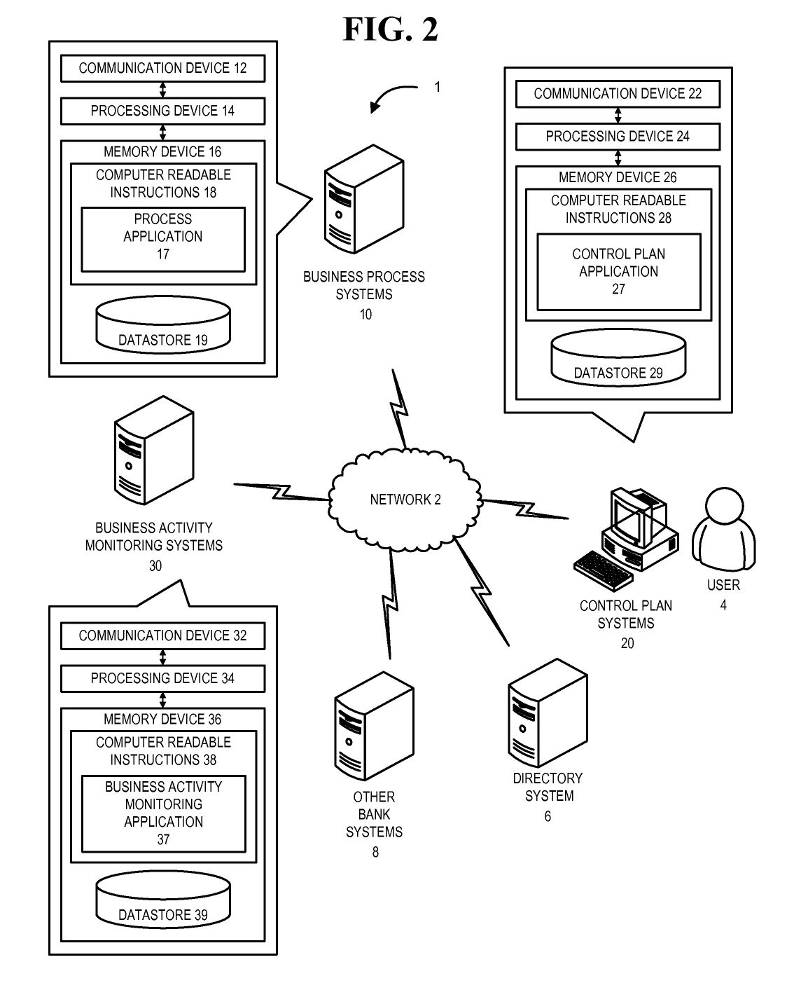

FIG. 2 illustrates a control plan system environment 1, in accordance with an embodiment of the present invention. As illustrated in FIG. 2, the business process systems 10 are operatively coupled, via a network 2 to the control plan systems 20, business activity monitoring system 30, directory systems 6, and/or other bank systems 8. In this way, the business process system 10 can receive and send information from and to the control plan system 20, business activity monitoring system 30, directory systems 6, and/or other bank systems 8, to allow the user 4 to create and use the control plan for monitoring the critical metrics and key performance indicators of the business processes using the control plan systems 20.

The network 2 may be a global area network (GAN), such as the Internet, a wide area network (WAN), a local area network (LAN), or any other type of network or combination of networks. The network 2 may provide for wireline, wireless, or a combination of wireline and wireless communication between devices on the network.

In some embodiments of the invention, the users 4 are process owners, help desk employees, line of business employees, etc. Process owners are typically in charge of the control plans for the process for which they are assigned ownership. The process owners are charged with monitoring the control plans, making sure the process stays within the control limits, updating the process and control plans when necessary, fixing the process when the process is outside of the control limits, etc. The process owners often have a high rate of turnover, so much so that process owners can change multiple times throughout the stages of developing and implementing the process within the business (i.e., throughout the DMAIC six sigma process or other process improvement tool). In some cases the control plan can become static over time because new process owners are not made fully aware of the control plan and monitoring requirements therein by their predecessors. Ideally, process owners should be notified when a business process becomes outside of control plan limits so that the process owners are aware of any issues that could cause customer dissatisfaction or profit losses to the business immediately as they occur. After being notified, the process owners could make sure that the right employees are notified of the process issues in order to fix the process in a timely manner. Help desk employees are often the employees that have the technical experience to fix process issues relating to the computer systems associated with the process. Line of business employees may be the employees that can provide work-arounds, or take the necessary actions to fix the process when the process is outside of the control limits. The line of business employees may also help with determining if the process control issue is a one-time occurrence or a more serious issue that requires additional investigation and business process changes.

As illustrated in FIG. 2, the business process systems 10 generally comprise a communication device 12, a processing device 14, and a memory device 16. As used herein, the term “processing device” generally includes circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 14 is operatively coupled to the communication device 12 and the memory device 16. The processing device 14 uses the communication device 12 to communicate with the network 2 and other devices on the network 2, such as, but not limited to, the control plan systems 20, business activity monitoring systems 30, directory systems 6, and/or other bank systems 8. As such, the communication device 12 generally comprises a modem, server, or other device for communicating with other devices on the network 2.

As further illustrated in FIG. 2, the business process systems 10 comprise computer-readable instructions 18 stored in the memory device 16, which in one embodiment includes the computer-readable instructions 18 of a business process application 17. In some embodiments, the memory device 16 includes a datastore 19 for storing data related to the business process systems 10, including but not limited to data created and/or used by the business process application 17.

The business process application 17 is an application that is related to running a business process or system used for the business process. The business process application 17 may be part of the business process system 10 that the user 4 wants to monitor. The business process application 17 communicates with the control plan application 27 used to monitor the business process, and/or the business activity monitoring application 37 that captures information related to the critical metrics and key performance indicators for the control plan application 27 in order to allow the user 4 to monitor the business process. In one embodiment of the invention, the business process application 17, may be an image cash letter application, which is used in an image cash letter process to receive image cash letters, balance the image cash letters, and/or send image cash letters to the proper financial institutions. However, an important part of the invention is that the customized control plan process 100 can be applied to one or more business processes and the image cash letter process is used herein as an example of a business process.

As further illustrated in FIG. 2, the control plan systems 20 generally comprise a communication device 22, a processing device 24, and a memory device 26. The processing device 24 is operatively coupled to the communication device 22 and the memory device 26. The processing device 24 uses the communication device 22 to communicate with the network 2, and other devices on the network 2, such as, but not limited to, the business process system 10, the business activity monitoring system 30, directory systems 6, and/or other bank systems 8. As such, the communication device 22 generally comprises a modem, server, wireless card, and/or other device(s) for communicating with other devices on the network 2 and/or comprises a display, camera, keypad, mouse, keyboard, microphone, and/or speakers for communicating with one or more users 4.

The control plan application 27 allows the users 4 to establish, edit, and view a customized control plan for a business process. The user 4 can determine the control plan limits, determine a process control owner, determine notification alerts when the process is outside of the control limits, determine how the business process monitoring is displayed in a dashboard, etc. in order to develop a dynamic control plan that automatically monitors a business process and notifies the proper employees when the business process steps are outside of the control limits of the control plan.

As further illustrated in FIG. 2, the business activity monitoring system 30 generally comprises a communication device 32, a processing device 34, and a memory device 36. The processing device 34 is operatively coupled to the communication device 32 and the memory device 36. The processing device 34 uses the communication device 32 to communicate with the network 2, and other devices on the network 2, such as, but not limited to, the business process systems 10, the control plan systems 20, the directory systems 6, and/or the other bank systems 8. As such, the communication device 32 generally comprises a modem, server, or other devices for communicating with other devices on the network 2.

As illustrated in FIG. 2, the business activity monitoring system 30 comprises computer-readable program instructions 38 stored in the memory device 36, which in one embodiment includes the computer-readable instructions 38 of a business activity monitoring application 37. In some embodiments, the memory device 36 includes a datastore 39 for storing data related to the business activity monitoring system 30, including but not limited to data created and/or used by the business activity monitoring application 37.

The business activity monitoring application 37 accesses the data from business processes that are run by the respective business process systems 10 and business process applications 17. The business activity monitoring application 37 may either capture the information and send the information to the control plan application 27, or in other embodiments the control application 27 may request that the business activity monitoring application 37 capture specific information from the respective business process systems 10. As discussed further below, the control plan application 27 uses the information provided by the business activity monitoring application 37 to create the customized control plans.

The directory systems 6 are operatively coupled to the business process systems 10, control plan systems 20, business activity monitoring systems 30, and/or other bank systems 8 through the network 2. The directory systems 6 have systems with devices the same or similar to the devices described for the business process systems 10, control plan systems 20, and/or business activity monitoring systems 30 (i.e., communication device, processing device, memory device with computer-readable instructions, datastore, etc.). Thus, the directory systems 6 communicate with the business process systems 10, control plans systems 20, and/or other bank systems 8 in the same or similar way as previously described with respect to each system. The directory systems 6, in some embodiments, are comprised of the list of users 4 employed by the business, as well as the user's job titles, locations, and/or other employment information, such as but not limited to the business lines, groups, and business processes with which the users 4 are associated. Therefore, when an employee is assigned to a new job, and for example becomes a process owner for a control plan, the control plan is automatically updated with the new process owner and contact information for the process owner. Therefore, when the business process becomes or is trending to become outside of the control limits of the control plan, then the control plan application can send an alert to the proper process owner to investigate the reason why the process is outside of the control limits.

The other bank systems 8 are operatively coupled to the business process systems 10, control plan systems 20, business activity monitoring systems 30, and/or directory systems 6 through the network 2. The other bank systems 8 have systems with devices the same or similar to the devices described for the business process systems 10, control plan systems 20, and/or business activity monitoring systems 30 (i.e. communication device, processing device, memory device with computer-readable instructions, datastore, etc.). Thus, the other bank systems 8 communicate with the business process systems 10, control plan systems 20, and/or business activity monitoring systems 30 in the same or similar way as previously described with respect to each system. The other banks systems 8 may have information related to the business process or other information that is used by the business activity monitoring application 37 and/or control plan application 17 in order to monitor the customized control plans.

It is understood that the servers, systems, and devices described herein illustrate one embodiment of the invention. It is further understood that one or more of the servers, systems, and devices can be combined in other embodiments and still function in the same or similar way as the embodiments described herein.

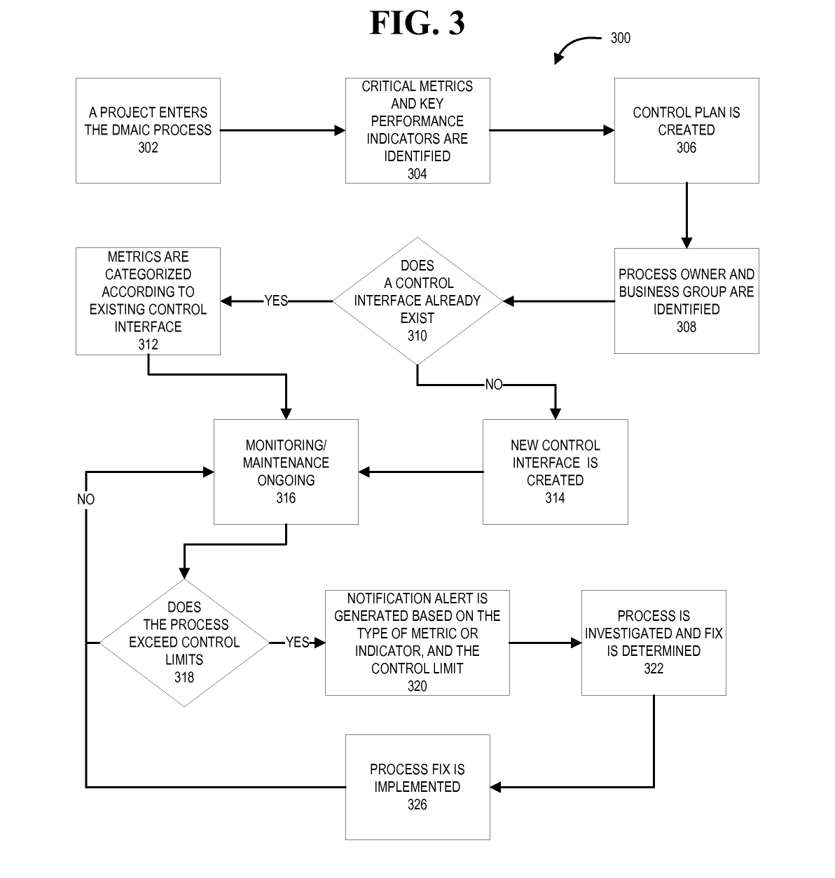

FIG. 3 illustrates a detailed customized control plan process 300 in accordance with one embodiment of the invention. As illustrated by block 302, the DMAIC methodology is applied to a project in order to create or improve a business process. During the control phase of the DMAIC methodology critical metrics and key performance indicators are identified for tracking within the control plan, as illustrated in block 304. For example, in one embodiment of the invention the business process is an image cash letter process, in which image cash letters are received by the financial institution; the individual checks within the image cash letters are balanced and analyzed for accuracy; and the check images are repackaged into other image cash letters that are sent to the proper financial institutions for settlement. Within the image cash letter process the critical metrics and key performance indicators may include the volume of image cash letters being received, balanced, and sent; the speed at which the image cash letters are received, balanced, and sent; any defects in the image cash letters being received, balanced, and sent; and the amount of money associated with the image cash letters being received, balanced, and sent, to name a few. In other embodiments of the invention, other critical metrics and key performance indicators may be identified for tracking by the control plan.

Thereafter, as illustrated by block 306, the control plan is created for the business process. In some embodiments, the control plan may include determining the control limits within which each metric should operate. In some embodiments of the invention the control limits can be determined though the use of a process improvement tool, such as a six-sigma process improvement tool. For example, the six-sigma process can be applied to the data captured from the business process by the business activity monitoring systems 30, in order to determine the one-sigma, two-sigma, three-sigma, four-sigma, five-sigma, and six-sigma process limits. In some embodiments the user 4 may determine that a particular process step should be controlled within a three-sigma process limit, while other steps of the process may be controlled within other process limits, such as six-sigma process limits.

In some embodiments of the invention, one or more metrics being tracked in the control plan may be weighted with respect to the other metrics being tracked, or alternatively with respect to various control limits (i.e., three-sigma vs. six-sigma limits) for the metric. Therefore, if more than one metric is outside of the control limits the control plan may require that the process owner investigates and fixes one metric before another. For example, if the volume of image cash letters received is outside of the control limits and the defects of the image cash letters received are outside of the control limits, weighting factors may determine that the process owner or business line employee fixes the volume issue before the defect issue, or visa versa. For example, in other embodiments of the invention, the volume of the image cash letter received may be outside the three-sigma limits while the defects of the image cash letters received may be outside of the six-sigma limits, as such weighting factors may determine that the process owner or business line employee fixes the defects issue before the volume issue.

In other embodiments of the invention, the user 4 can weight the various control limit metrics within the control plan. For example, the user 4 may determine that a process step operating out of the control limits at a first level does not require immediate action, while the process step of operating out of the control limits at a second level does require immediate action. In one embodiment, the user 4 may set up different levels of control limits, such as warning limits, severe limits, critical limits, etc. in order to monitor the process. For example, the user 4 may set up control limits of two-sigma (i.e., warning limit), three-sigma (i.e., severe limit), and/or six-sigma (i.e. critical limit) on the same metric for a business process step. In this way the user 4, may be notified when the metric for a business process step is outside of the two-sigma warning limit and approaching or outside of the three-sigma severe limit and/or six-sigma critical limit.

The user 4 has the ability to assign various limits (i.e., warning, severe, critical, etc.) to various metrics or indicators for one or more process steps within the control plan. In other embodiments of the invention other types of process improvement tools can be used to define the control limits of a control plan, or the user 4 may randomly select one or more control limits to track within a control plan.

With respect to the image cash letter process describe herein, the user 4 may for example set control limits on the volume of image cash letters, the speed at which the image cash letters are processed, the number of defects in the image cash letters, and/or the money associated with the image cash letters for the receive, balance, and send steps. For example, with respect to the volume of image cash letters received the user 4 may set a warning limit of two-sigma and a severe limit of three-sigma on the volume of image cash letters received. The user 4 may attached an e-mail notification to the warning limit, and a telephone call notification to the severe limit. In this way, when the volume of image cash letters received by the financial institution exceeds the warning limit an e-mail is sent to the process owner or other employee indicating that the process is trending outside of the control limits. Furthermore, when the volume of the image cash letters received by the financial institution exceeds the severe limit a phone call may be placed to the process owner or other employee indicating that the process is outside of the control limit. In another example, with respect to the defects of image cash letters received, the user 4 may set a warning limit of plus two-sigma and a severe limit of plus three-sigma (i.e., notifications are only made when the defects are above the upper control limit) on the number of defects received within the volume of image cash letters received. The user 4 may attached an e-mail notification to the warning limit, and a telephone call notification to the severe limit. In this way, when the number of defective image cash letters received by the financial institution exceeds the warning limit an e-mail is sent to the process owner or other employee indicating that the process is trending outside of the control limits. Furthermore, when the number of defective image cash letters received by the financial institution exceeds the severe limit a phone call may be placed to the process owner or other employee indicating that the process is outside of the control limit. The control limits may be placed on various metrics or indicators for one or more process steps.

As illustrated by block 308, after the control plan is created the process owner and business groups responsible for the business process are identified and listed as contacts in the control plan. Therefore, when the business process metrics and identifiers move outside of the control limits the process owner and business groups identified as being responsible for the business process, or other employees, may be sent notification alerts. In some embodiments of the invention, the process owners and business groups responsible for the business processes are identified and linked through the directory system 6. In this way, whenever the process owner or business group responsible for a business process changes in the directory system, the contact information for the new process owner or business group is automatically updated by the control plan. Therefore, whenever a process owner or business group changes the new process owner and business group will receive any notification alerts related to metrics that are outside of the control limits or trending toward becoming outside of the control limits.

As illustrated by decision block 310, it is determined, either automatically by the control plan application 27 or manually by the user 4, if a control interface already exists for the control plan developed in block 306. As illustrated by block 312, if the control plan interface already exists the critical metrics and key performance indicators are categorized according to the existing control plan interface. However, if the control plan interface does not exist a new customized control plan interface is automatically created by the control plan application 27, as illustrated by block 314.

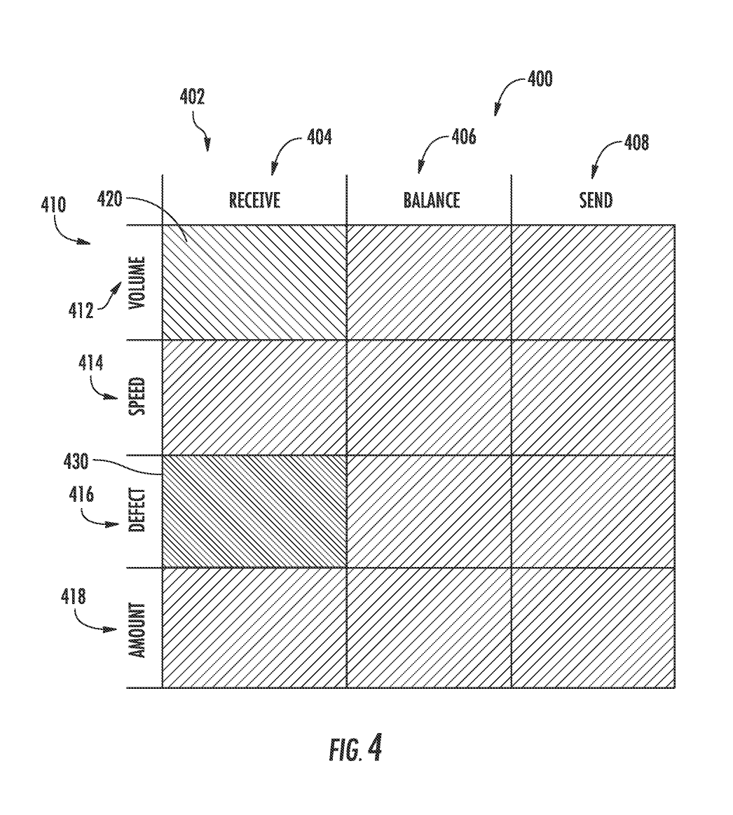

FIG. 4 illustrates one embodiment of a control plan interface for the image cash letter interface 400. As illustrated in the image cash letter interface 400, the high level process steps are listed in the column header 402, such as the receive column 404, the balance column 406, and the send column 408. The critical metrics and key performance indicators are listed in the row headers 410, such as the volume row 412, the speed row 414, the defect row 416, and the amount header 418. In other embodiments of the invention, other types of critical metrics and key performance indicators may be used in the customized control plan interface.

In one embodiment of the customized control plan interface the critical metrics and key performances indicators are monitored based on status indicators 450, as illustrated in FIG. 4. The status indicators 450, as represented by the cross-hatching in FIG. 4 to illustrate different shades of gray, different colors, etc., allow a user 4 to see if the metric or indicator is within or outside of the control limits determined during development of the control plan. For example, in some embodiments if the process step is within a first level limit for the associated metric or indicator, then the control plan interface may display the status indicator 450 as light gray (in some embodiments the status indicator may be displayed in green), which may indicate that the metric or indicators for the associated process step are within the control limits. If the process is between a first level limit and a second level limit then the status indicator 450 for the process step and associated metric or indicator may be displayed in gray (in some embodiments the indicator may be displayed in yellow), which may indicate that the metric or indicator for the associated process step is out of control or may become out of control. If the process is outside of the second level limit then the process step and associated metric or indicator may be displayed in dark gray (in some embodiments the status indicator may be displayed in red), which may indicate that the metric or indicator is out of control. In other embodiments of the invention other colors or shades of gray may be displayed for other control limits, such as but not limited to a third level limit, a fourth level limit, a fifth level limit, a sixth level limit, etc. (i.e. one through six sigma levels, etc.). In other embodiments of the invention other status indicators 450 may be used to display if the status of a metric for a process step is within or outside of one or more control limits.

As illustrated by block 316, the customized control interface may be monitored by a user 4 charged with monitoring one or more customized control interfaces, or the customized control interface may be monitored automatically by the control plan application 27. As illustrated by block 318, the control plan application 27 receives information from the business activity monitoring systems 30 regarding the critical metrics and key performance indicators of the business process steps and determines if any of the critical metrics and key performance indicators exceed the control limits. As illustrated by block 316, if the critical metrics and key performance indicators do not exceed the control limits then the user 4 or control plan application 27 continues to monitor the control plan. As illustrated by block 320, if the critical metrics and key performance indicators do exceed the control limits (i.e., the process is outside of the first level limits, second level limits, third level limits, etc.) then an automated notification alert, such as an e-mail alert or a telephone alert, is made based on the notification alerts assigned by the user 4 when developing the control plan. Furthermore, in some embodiments of the invention, if the critical metrics and key performance indicators exceed one or more control limits then one or more notification alerts may be sent to process owners, other employees, etc. For example, if the metrics are outside of both the first level limits and second level limit, both an e-mail may be sent to the process owner and a telephone call placed to the process owner.

As illustrated by block 322, the user 4, if necessary, will investigate the business process step and fix the process in order of the weighted importance, depending on whether or not the notification alert requires immediate attention. For example, as illustrated in the image cash letter interface 400 in FIG. 4, the volume indicator for the receive step 420 is gray (as represented by the different type of cross-hatching) indicating that the process is out of control or becoming out of control. In some embodiments of the invention the control plan application 27 can automatically contact the process owner or the business group in order to investigate the reason volume indicator for the receive step 420 is gray.

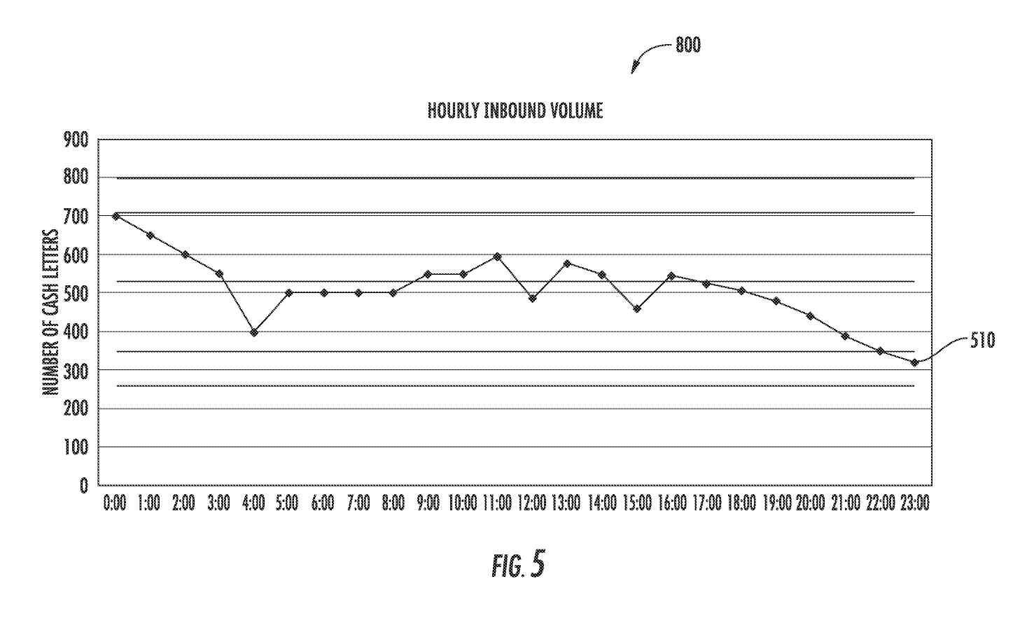

In order to investigate the metric that is out of control the user 4, such as a process owner, a person from the business group, or the person monitoring the control plan interface, may select the status indicator 450 for the process step with the metric that is out of control. In some embodiments of the invention, the user 4 may be able to view charts, graphs, tables, etc. related to the critical metric or key performance indicator for the process step selected. For example, after selecting the volume status indicator for the receive step 420 a process owner may view the hourly inbound volume chart 500 as illustrated in FIG. 5. The hourly inbound volume chart 500 may display the number of cash letters received by one or more process servers in the financial institution on a per hour basis. For example, as illustrated by point 510 at hour twenty-three (23) only approximately three-hundred and twenty five (325) cash letters were received between hour twenty-two (22) and hour twenty-three (23). The process owner can investigate the reason why the number of volume of image cash letters has fallen below the two-sigma control limit. In some embodiments, the reason for the status indicator is that the server may not be working properly, the specific time of day typically has low image cash letter volumes, the systems of a business providing the image cash letters may be out of service, etc.

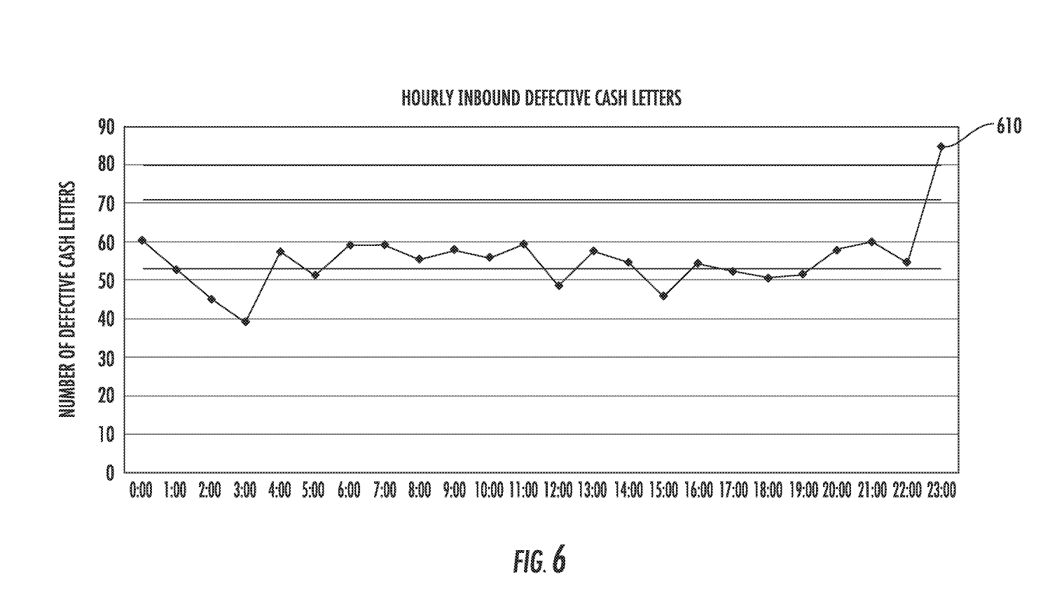

In other embodiments of the invention the defect indicator for the receive step 430 may be shaded dark gray (as represented by the different type of cross-hatching), indicating that the metric is outside of the upper three-sigma control limit. The user 4, such as the process owner, may select the defect status indicator for the receive step 430 in order to investigate the reasons that the defect status indicator for the receive step 430 is outside the upper three-sigma control limit. After selecting the defect status indicator for the receive step 430 a process owner may view the hourly inbound cash letter defect chart 600, as illustrated in FIG. 6. The hourly inbound cash letter defect chart 600 may display the number of cash letters received by one or more process servers in the financial institution that have defects on a per hour basis. For example, as illustrated by point 610 at hour twenty-three (23) approximately eighty-five (85) cash letters received had defects between hour twenty-two (22) and hour twenty-three (23). The process owner can investigate the reason why the number of cash letter defects increased above the upper three-sigma control limit. In some embodiments an image systems of the financial institution may not be working properly, the image systems of a business providing the cash letters may be out of service, etc.

As illustrated by block 324, once the user 4 determines the fix for the business process, if any, the fix may be implemented and the control plan application 27 continues to monitor the control plan, as illustrated by block 316.

As will be appreciated by one of ordinary skill in the art in view of this disclosure, the present invention may be embodied as an apparatus (including, for example, a system, machine, device, computer program product, and/or the like), as a method (including, for example, a business process, computer-implemented process, and/or the like), or as any combination of the foregoing. Accordingly, embodiments of the present invention may take the form of an entirely software embodiment (including firmware, resident software, micro-code, etc.), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, etc.) that can direct a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A system, comprising:
a memory device;
a communication device; and
a processing device operatively coupled to the memory device and the communication device, wherein the processing device is configured to execute computer-readable program code to:
receive a metric for monitoring a process step within a business process;
receive a first control limit associated with the metric;
generate a customized control plan based on the metric, the first control limit, and the process step;
receive metric data for the process step; and
generate a first notification alert when the metric data violates the first control limit.

2. The system of claim 1, wherein there are two or more metrics for monitoring two or more process steps for the business process.

3. The system of claim 1, wherein the processing device is further configured to execute computer-readable program code to display to a user the customized control plan in a customized control plan interface with a status indicator, wherein the status indicator illustrates if the metric violates the first control limit.

4. The system of claim 1, wherein the processing device is further configured to execute computer-readable program code to receive a second control limit associated with the metric and generate a second notification alert when the metric data violates the second control limit, wherein the first notification alert is a first form of communication and the second notification alert is a second form of communication.

5. The system of claim 1, wherein the processing device is further configured to execute computer-readable program code to automatically receive notification contact information of a second process owner when a first process owner for the customized control plan is replaced by the second process owner, and update the customized control plan with the notification contract information of the second process owner.

6. The system of claim 1, wherein the processing device is further configured to execute computer-readable program code to receive the metric data for the process step from a business activity monitoring system that captures metric data from business systems.

7. The system of claim 1, wherein the processing device is further configured to execute computer-readable program code to receive the metric data for the process step from a business system that executes the process step.

8. The system of claim 1, wherein the processing device is further configured to execute computer-readable program code to generate a chart for the metric based on the metric data illustrating the metric data over time as the metric data relates to the first control limit.

9. A method comprising:
receiving a metric for monitoring a process step within a business process;
receiving a first control limit associated with the metric;
generating a customized control plan based on the metric, the first control limit, and the process step, through the use of a processing device;
receiving metric data for the process step; and
generating a first notification alert when the metric data violates the first control limit.

10. The method of claim 9, wherein there are two or more metrics for monitoring two or more process steps for the business process.

11. The method of claim 9, further comprising:
displaying to a user the customized control plan in a customized control plan interface with a status indicator, wherein the status indicator illustrates if the metric violates the first control limit.

12. The method of claim 9, further comprising:
receiving a second control limit associated with the metric and generate a second notification alert when the metric data violates the second control limit, wherein the first notification alert is a first form of communication and the second notification alert is a second form of communication.

13. The method of claim 9, further comprising:
receiving notification contact information of a second process owner automatically when a first process owner for the customized control plan is replaced by the second process owner, and update the customized control plan with the notification contract information of the second process owner.

14. The method of claim 9, wherein receiving the metric data for the process step comprises receiving the metric data for the process step from a business activity monitoring system that captures metric data from business systems.

15. The method of claim 9, wherein receiving the metric data for the process step comprises receiving the metric data for the process step from a business system that executes the process step.

16. The method of claim 9, further comprising:
generating a chart for the metric based on the metric data illustrating the metric data over time as the metric data relates to the first control limit.

17. A computer program product, the computer program product comprising at least one non-transitory computer-readable medium having computer-readable program code portions embodied therein, the computer-readable program code portions comprising:
an executable portion configured for receiving a metric for monitoring a process step within a business process;
an executable portion configured for receiving a first control limit associated with the metric;
an executable portion configured for generating a customized control plan based on the metric, the first control limit, and the process step, through the use of a processing device;
an executable portion configured for receiving metric data for the process step; and
an executable portion configured for generating a first notification alert when the metric data violates the first control limit.

18. The computer program product of claim 17, wherein there are two or more metrics for monitoring two or more process steps for the business process.

19. The computer program product of claim 17, further comprising an executable portion for displaying to a user the customized control plan in a customized control plan interface with a status indicator, wherein the status indicator illustrates if the metric violates the first control limit.

20. The computer program product of claim 17, further comprising an executable portion for receiving a second control limit associated with the metric and generate a second notification alert when the metric data violates the second control limit, wherein the first notification alert is a first form of communication and the second notification alert is a second form of communication.

21. The computer program product of claim 17, further comprising an executable portion for receiving notification contact information of a second process owner automatically when a first process owner for the customized control plan is replaced by the second process owner, and update the customized control plan with the notification contract information of the second process owner.

22. The computer program product of claim 17, wherein the executable portion configured for receiving the metric data for the process step comprises receiving the metric data for the process step from a business activity monitoring system that captures metric data from business systems.

23. The computer program product of claim 17, wherein the executable portion configured receiving the metric data for the process step comprises receiving the metric data for the process step from a business system that executes the process step.

24. The computer program product of claim 17, further comprising an executable portion for generating a chart for the metric based on the metric data illustrating the metric data over time as the metric data relates to the first control limit.
